(19) United States
(12) Patent Application Publication
(10) Pub. No.: US 2009/0206211 A1
(43) Pub. Date: Aug. 20, 2009

(54) COLLAPSIBLE STAND

(75) Inventor: Carrie L. Goodman, West Chester, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: SNACK CADDY, LLC, WEST CHESTER, PA (US)

(21) Appl. No.: 12/372,431

(22) Filed: Feb. 17, 2009

Related U.S. Application Data
(60) Provisional application No. 61/029,274, filed on Feb. 15, 2008.

(51) Int. Cl. F16M 11/24; F16M 11/00; F16M 11/26

(52) U.S. Cl. 248/150; 248/165

(57) ABSTRACT

A collapsible stand is disclosed. The stand includes a frame that moves between a closed state and an opened state. A jacket fits over at least a portion of the frame, and a plurality of receptacles are supported on the frame. Also disclosed is a method for using the frame by closing and opening the frame.

### CROSS REFERENCE TO RELATED APPLICATION

This application claims the benefit of U.S. Provisional Patent Application No. 61/029,274, which is incorporated by reference as if fully set forth.

### FIELD OF INVENTION

The invention relates to a collapsible stand and method for using the same.

### BACKGROUND

Many events involve the service of food and beverage items. These foods are typically displayed and served in receptacles such as bowls or on plates which are set out on a table. It is often desirable to serve or display food in settings where tables and conventional receptacles are unavailable or difficult to transport, such as outdoors. Popular outdoor activities in which food may be served include picnics or barbeques, camping, and tailgating.

A need therefore exists to provide a lightweight, easily transportable service stand. Such a device should be lightweight, and transitionable between a compact state in which it can be easily transported, and an expanded state in which it can accommodate added weight and remain stable.

### SUMMARY

The present description provides a collapsible stand that moves between a closed state that is compact and an opened state that supports added weight and is stable. A jacket fits over at least a portion of the frame, and a plurality of receptacles are supported on the frame.

The present description also provides a stand including an upper frame that moves between a compact closed position and an expanded opened position. At least three supports are connected to the upper frame and are biased toward the opened position. A plurality of receptacles are supported on the upper frame.

### BRIEF DESCRIPTION OF THE DRAWINGS

FIG. 1 is a perspective view of a first embodiment of the closed stand in its cover;

FIG. 2 is a perspective view of the stand of FIG. 1 in the opened state with a pocketed jacket;

FIG. 3 is an elevation of the closed stand with the jacket partially removed;

FIG. 4 is an elevation of the closed stand with the legs extended;

FIG. 5 is an elevation of the fully opened stand with the jacket partially removed;

FIG. 6 is a partial cross section of a preferred leg in a collapsed state;

FIG. 7 is a partial cross section of the leg of FIG. 6 in the expanded state;

FIG. 8 illustrates a first way of attaching the jacket to the stand;

FIG. 9 illustrates a second way of attaching the jacket to the stand;

FIG. 10 illustrates a second embodiment of the stand, within a partial jacket;

FIG. 11 illustrates the rotation of the leg of FIG. 10 in the opened state, the legs partially expanded, and the jacket partially removed;

FIG. 12 is a cross section taken along line 12-12 of FIG. 10;

FIG. 13 illustrates a third embodiment of the stand;

FIG. 14 illustrates a leg of the stand of FIG. 13 in the expanded or opened state;

FIG. 15 is a cross section illustrating the detail of the leg of FIG. 13 in the closed state; and

FIG. 16 illustrates a fourth embodiment of the stand showing the opened legs in solid lines, and closed legs in dashed or phantom lines.

### DETAILED DESCRIPTION OF THE PREFERRED EMBODIMENTS

Referring to FIG. 2, the stand 10 includes a frame 20 that moves between opened and closed states. In the embodiment shown, a jacket 90 fits over a portion of the frame 20. Alternatively, the jacket 90 could cover the entire frame. A plurality of receptacles 92, 94, 100 are supported on the frame 20. The receptacles 92, 94, 100 may be used for storing various objects. In the example of FIG. 2, the receptacles are pockets 92, 94 and bowl 100. If desired, one or more of the pockets could be replaced with clips or shelves for supporting other bowls.

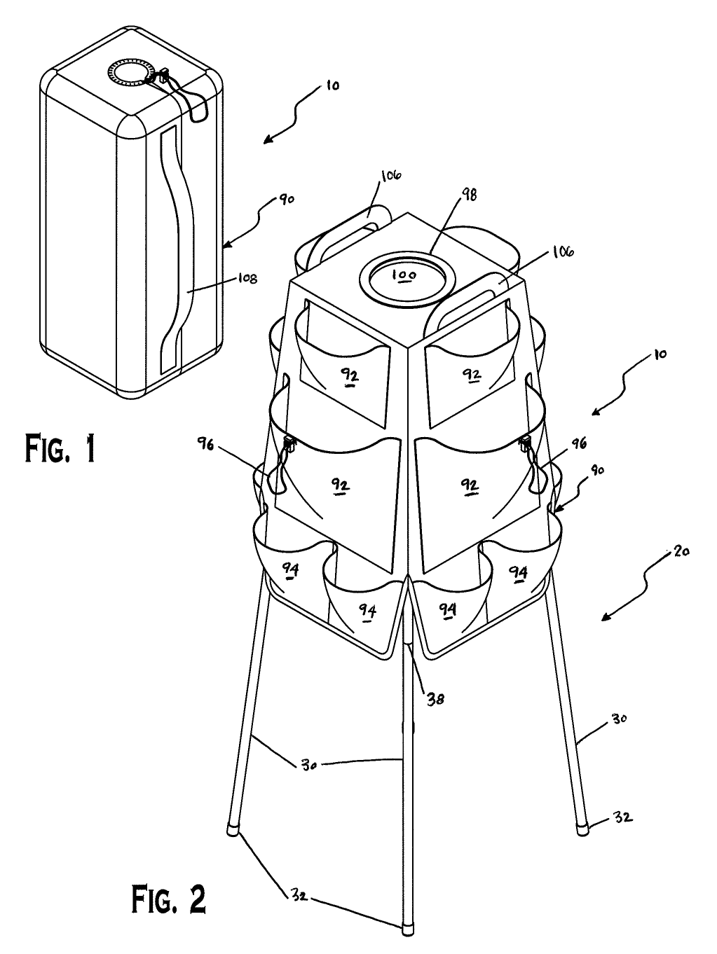

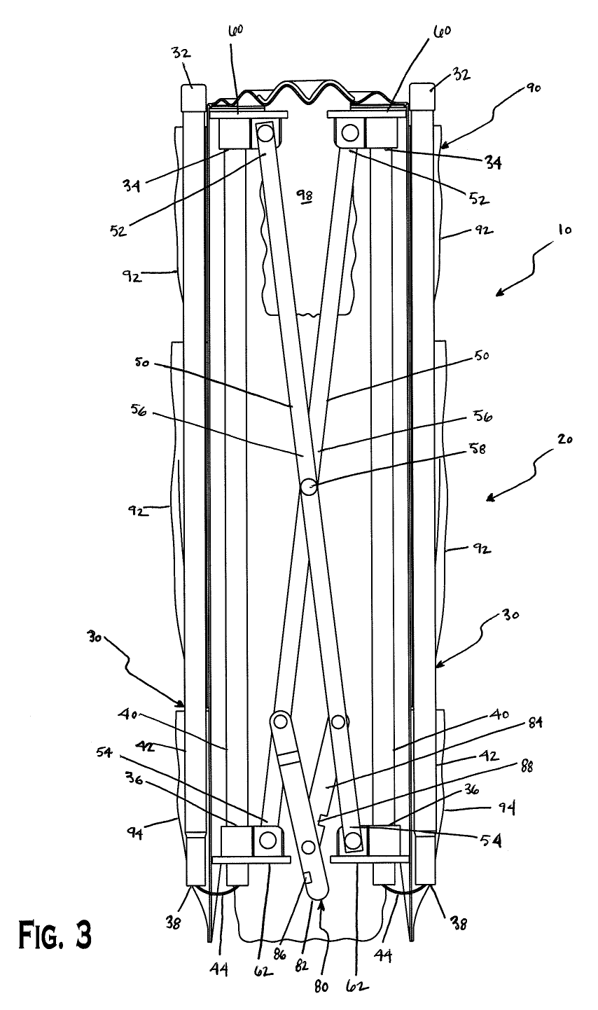

As shown in FIG. 3, the stand 20 is in a closed state. The jacket 90 may fit over all or a portion of the frame 20 while in the closed state. FIG. 1 illustrates the embodiment of FIGS. 2 and 3, in which the jacket 90 entirely encloses the frame 20 when in the closed state.

FIGS. 3-5 show the frame 20 in detail. The frame 20 includes a plurality of legs 30. Four legs 30 are illustrated in FIG. 2, but three or more legs 30 could be provided. The legs 30 can be made from a variety of rigid materials for supporting the stand, and are preferably constructed to minimize weight. The legs 30 may be made from metal or plastic, and may be formed as hollow tubes.

The legs 30 may include feet 32 for supporting the frame 20 on a surface. The feet 32 are disposed at a lower end of each of the legs 30, and are preferably made of a high friction material that will minimize slipping, such as rubber. Alternatively, the feet 32 may be wheels that permit the stand 10 to be easily moved without lifting; however, it is envisioned that at least one wheel would lock against further movement.

In the embodiment shown in FIGS. 3-5, the legs 30 are connected by support rods 50. The legs 30 are spaced apart about a perimeter of the frame, as shown in FIG. 2, and the support rods 50 connect each of the legs 30 with adjacent legs on opposite sides thereof. Each of the support rods 50 has a first end 52 pivotally connected to one of the legs 30, and a second end 54 pivotally connected to an adjacent leg 30. By pivoting the support rods 50 with respect to the legs 30, the legs 30 are brought closer together or further apart to move the frame 20 between the opened and closed states in a scissor like fashion.

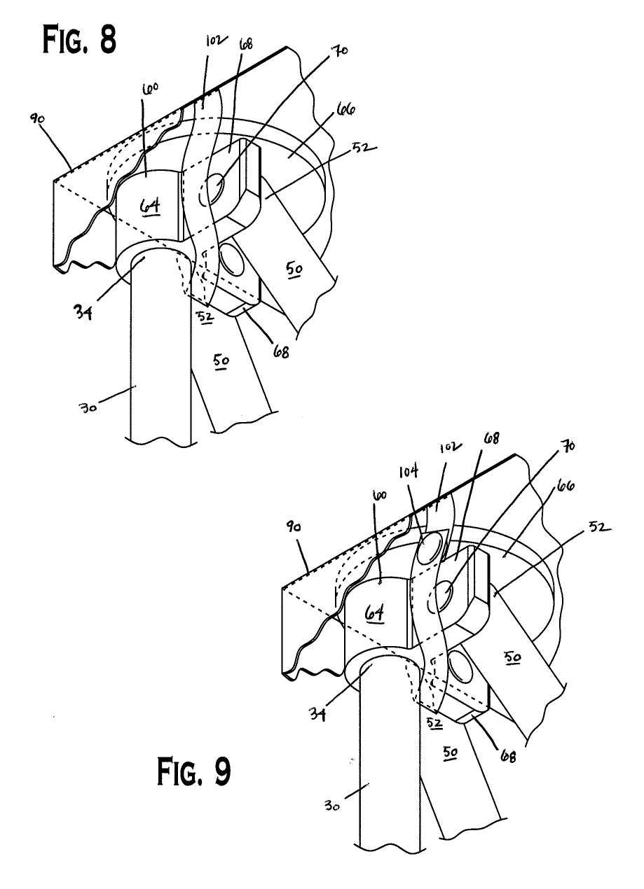

In the illustrated embodiment, pivotal connections between the legs 30 and support rods 50 are formed by joints 60, 62. An upper joint 60 connects the first end 52 of each support rod 50 to an upper connecting portion 34 of a respective leg 30, and a lower joint 62 connects the second end 54 of each support rod 50 to a lower connecting portion 36 of a respective leg 30. As shown in FIGS. 8 and 9, the ends of two support rods connect to a common leg 30 at the same vertical locations, and can share a single joint 60.

In FIGS. 8 and 9, the upper joints 60 are shown in greater detail. Each upper joint 60 includes a cylindrical portion 62 that encloses a section of a respective leg 30. A base 66 supporting two flanges 68 extends radially from the cylindrical portion 64. An end portion 52, 54 of each of the support rods 50, the first end 52 in FIGS. 8 and 9, rests against a side of each flange 68. Pins 70 extend through each of the flanges 68 and the end portion 52 a respective support rod 30 to create a pivotal coupling between the two. The lower joints 62 can have the same configuration, with the second ends 54 of the support rods 30 being affixed thereto in the same manner.

To open the frame 20 of the embodiment shown, the support rods 50 are each pivoted at the joints 60, 62 to increase the angle formed between it and each of the attached legs 30, moving the legs 30 further apart. To close the frame 20, the support rods 50 are each pivoted to decrease the angle formed between it and each of the attached legs 30, moving the legs 30 further apart. The support rods 50 could take up any position with respect the legs 30 that permits this type of pivotal movement to open and close the frame 20.

In the embodiment shown in FIGS. 3-5 and 10-12, two support rods 50 connect each of the legs 30 to an adjacent leg 30. The two support rods 50 intersect, and are hinged together about respective central portions 56 thereof to produce an accordion hinge. The hinge may be formed by a pin 58 intersecting both support rods 50. Although not a necessary feature, the hinging of the two support rods 50 provides the frame 20 with additional stability while still permitting the pivotal opening and closing action of the legs 30.

The second end 54 of the support rod 50 slides along the length of the leg 30 to which it is affixed. Where the joints 60, 62 described above and shown in FIGS. 8 and 9 are provided, the sliding may take place through the lower joints 62. For example, the cylindrical portion 64 of each of the lower joints 62 may be affixed to the leg 30 in a manner that permits it to slide thereon. During opening and closing of the frame, the second end 54 of each support rod 50 slides along the leg 30 during the pivoting of the support rods 50 with respect to the legs 30. The second end 54 slides in an upward direction along the leg during opening of the frame 20, and in a downward direction during closing of the frame 20.

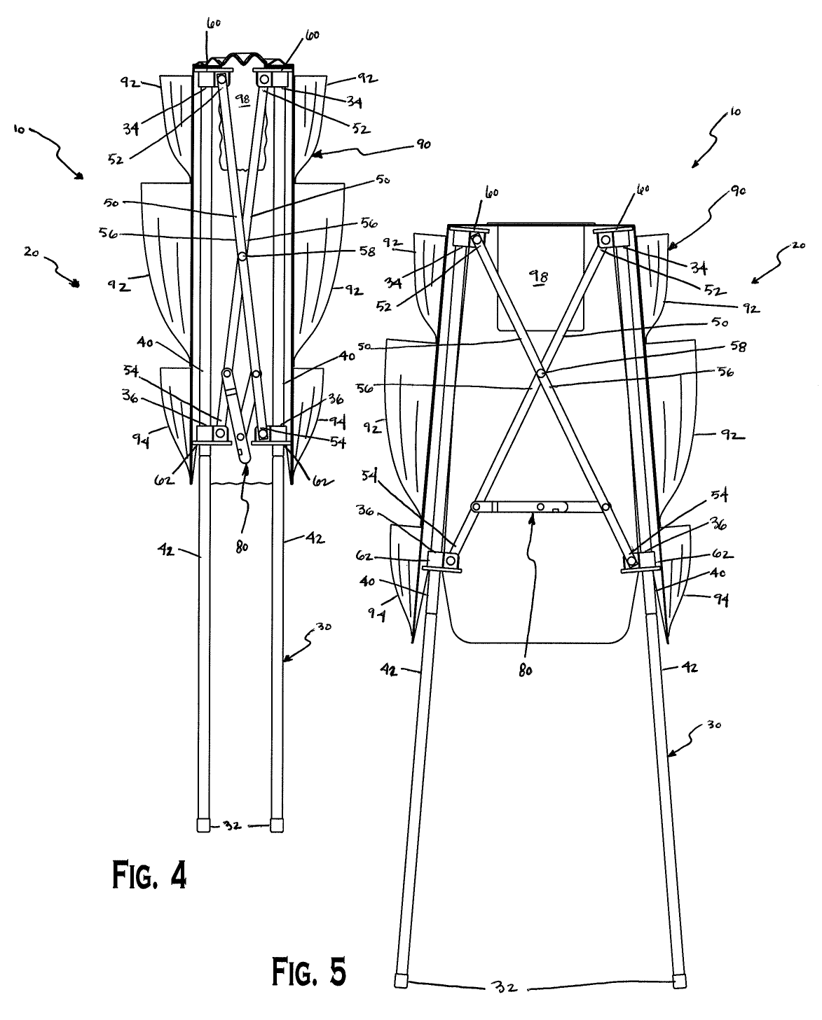

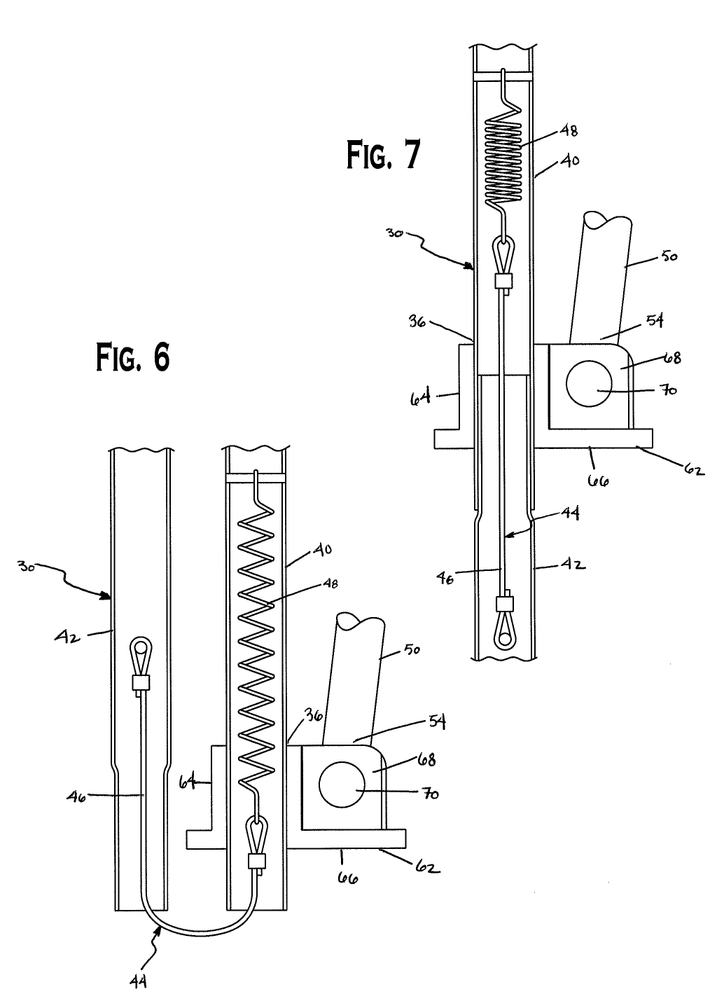

As shown in FIGS. 3-5, the frame can be held in the opened state by a locking mechanism 80. In the illustrated embodiment, the locking mechanism 80 is a pivoting latch. A first latch strip 82 is pivotally connected at a first end thereof to a first support rod 50, and at a second end thereof to a second end of latch strip 84 having a first end pivotally connected to an intersecting support rod 50. When the frame is in the closed position, as shown in FIGS. 3 and 4, the latch strips 82, 84 remain in a folded configuration. Upon opening of the frame, the strips 82, 84 pivot with respect to each other until parallel and aligned, as shown in FIG. 5. The first latch strip 82 includes a protrusion 86 received by an indentation 88 in the second latch strip 84 to prevent pivoting of the latch strips 82, 84 with respect to each other, and thus preventing pivoting of the support rods 50 with respect to each other, to lock the frame 20 in the opened position.

The legs 30 move between collapsed and expanded positions. As shown in FIGS. 3, 6 and 7, each of the legs 30 includes a break 38 that divides the leg 30 into an upper section 40 and a lower section 42. The break 38 permits the lower section 42 to pivot with respect to the upper section 40. The legs 30 are moved towards the expanded position by pivoting the lower section 42 with respect to the upper section 40 to increase an angle formed therebetween, and moved towards the collapsed position by pivoting the lower section 42 with respect to the upper section 40 to decrease an angle formed therebetween.

The leg breaks 38 of one embodiment are shown in detail in FIGS. 6 and 7. In this embodiment, the upper 40 and lower 42 sections are elongated tubes having respective ends 41, 43 that connect to form the break 38. The end 43 of the lower section 42 has a reduced diameter, and fits into the end 41 of the upper portion 40. The outer diameter of the lower section 42 is substantially equal to the inner diameter of the upper section 40 in the illustrated embodiment. This permits the end 43 of the lower section 42 to fit snugly within the end 41 of the upper section 42 and be retained therein by friction. Alternatively, the upper section 40 could have an end 41 of reduced diameter that fits within an end 42 of the lower section 42.

The legs 30 preferably include an extendable connector 44 that connects sections 40 and 42. The connectors 44 of the illustrated embodiment are attached inside the tubular bodes of the sections 40 and 42 of the leg, and extend through the breaks 38. The connectors 44 are preferably elastic. In the illustrated embodiment, each of the connectors 44 includes a cord 46 and a spring 48. Alternatively, the spring 48 could be omitted and the connectors could be formed of a length of elastic material. A first end 45 of the connector 44 is attached to the interior of the upper section 40 of the leg, while a second end 47 is attached to the interior of the lower section 42 of the leg. To collapse the legs 30, the upper 40 and lower sections 42 of the legs 30 are pulled apart to overcome the elastic force of the connectors 44. The end 43 of the lower leg section 42 can then be removed from the end 41 of the upper leg 40, and the legs 30 folded into the collapsed positions.

FIGS. 3 and 6 shows the legs 30 in the collapsed positions. As shown, the lower section 42 has been pivoted with respect to the upper 40 section such that the angle between the two is substantially eliminated and they extend parallel and adjacent to each other. In the illustrated embodiment, the upper 40 and lower sections 42 are substantially equal in length, permitting the legs 30 to essentially be folded in half when moved to the collapsed positions, thus reducing the length of the legs 30 by almost half to compact the frame 20. The space occupied by the frame 20 is thus greatly reduced when the frame 20 is moved into the closed state and the legs 30 are moved into the collapsed positions. Where this type of configuration is employed, the lower sections 42 are pivoted outwards with respect to the upper sections 40 to collapse the legs 30. As a result, the lower sections are disposed outward with respect to the remainder of the frame 20 when the legs 30 are collapsed.

FIGS. 4, 5, and 7, show the legs 30 in the expanded positions. As shown the upper 40 and lower sections 42 are parallel and aligned, extending outward at angles such that the bottom of the frame is wider than the top. While the legs 30 could be vertical, or the upper sections 40 could substantially vertical, with the lower sections 42 bent outwards at angles to create a widened base, the illustrated is believed to present a more stable configuration.

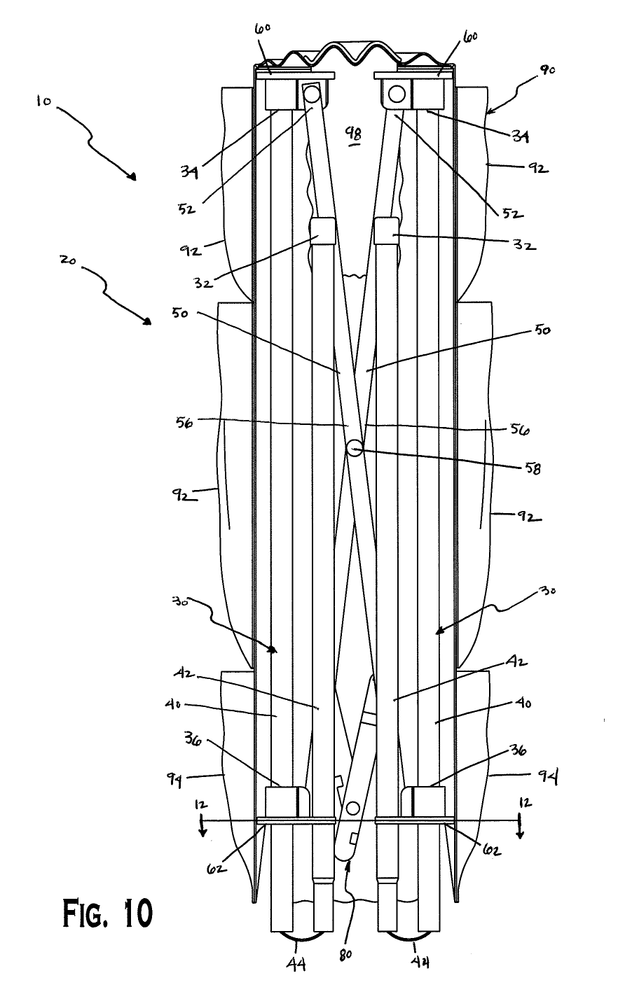

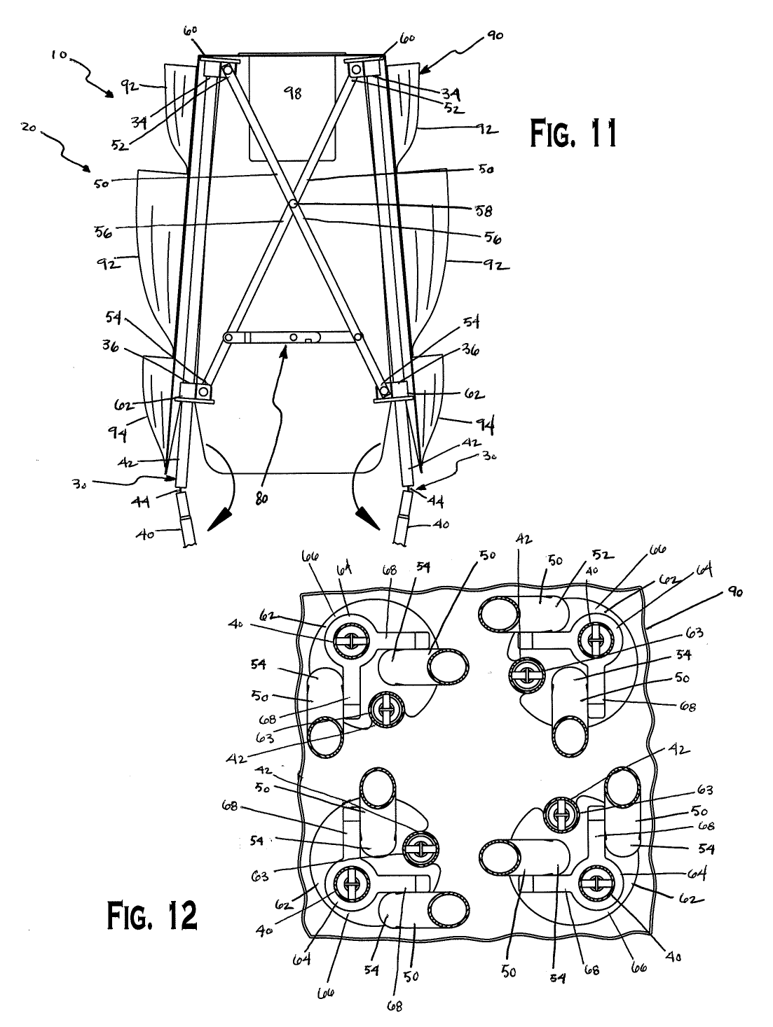

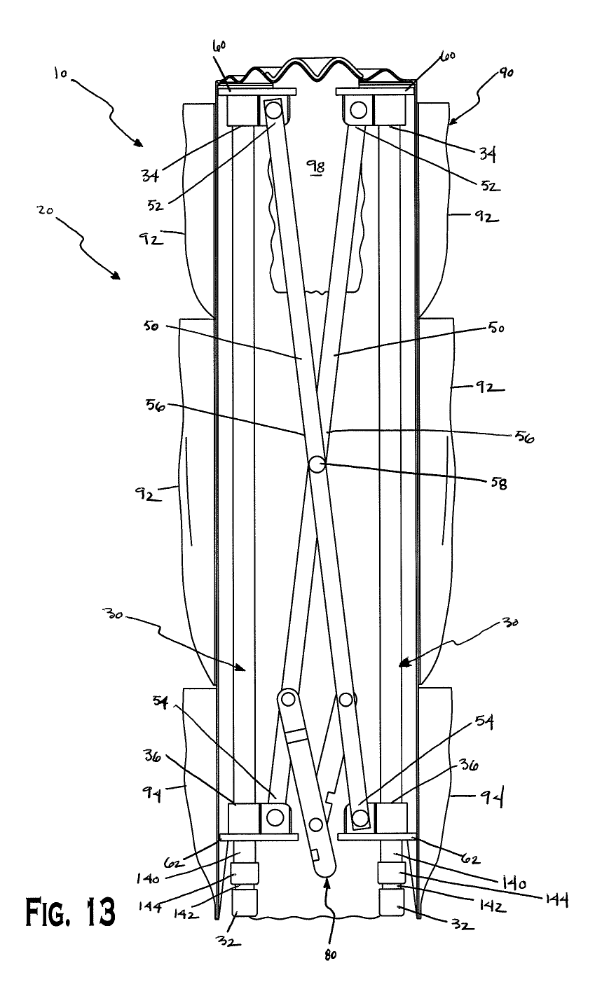

An embodiment having an alternative leg configuration is shown in FIGS. 10-12. In this embodiment, the lower sections 42 of the legs 30 are shorter than the upper sections 40. This permits the lower sections 42 to be pivoted inwardly as shown in FIG. 11, so that they are disposed inward with respect to the remainder of the frame 20 when in the collapsed state, as shown in FIG. 10. The lower sections 42 of this embodiment are short enough they can be pivoted inward of legs 30, without interference from other portions of the frame 20. As shown, the lower joints 62 are used to lock the legs in the collapsed positions. Referring to FIG. 12, the lower joints 62 each include an opening 63 that receives part of the lower section 42 of a respective leg 30. Preferably the lower sections 42 snapping to engagement with the openings and are retained therein to prevent pivoting with respect to the upper sections 40.

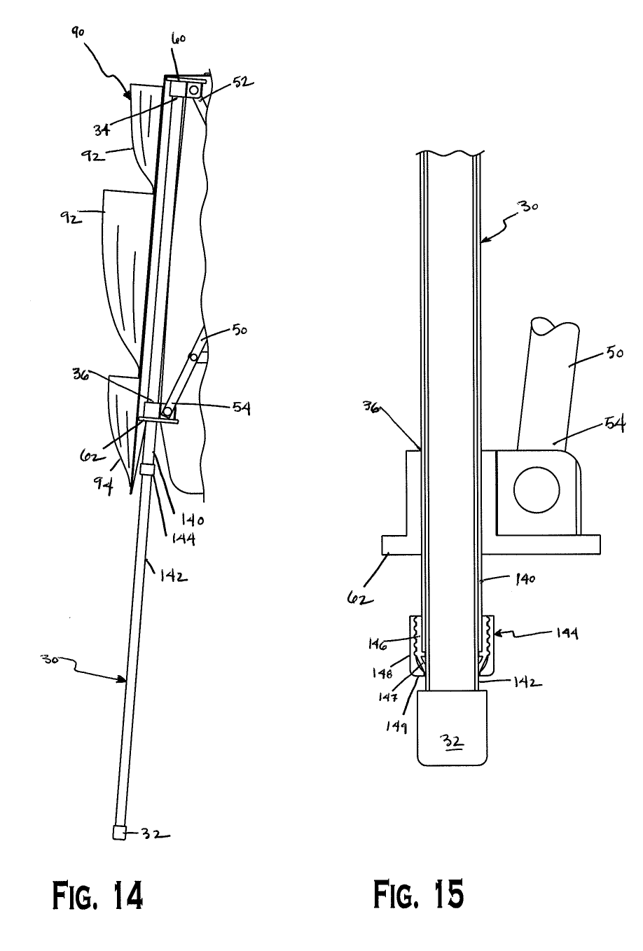

A further embodiment of the frame 20 having an alternative leg configuration is shown in FIGS. 13-15. In this embodiment the legs breaks 38 described above are omitted, and the frame 20 is instead provided with telescoping legs 30. The legs 30 include tubular upper 140 and lower sections 142. As shown in FIG. 15, the upper sections 140 have larger diameters than the lower sections 142, and the lower sections 142 are slidably disposed within the upper sections 140. To expand the legs 30, the lower sections 142 a slide out from the upper sections, as shown in FIG. 14, and to collapse the legs 30, the lower sections 142 slides into the upper sections 140, as show in FIG. 15. A friction nut 144 is provided to secure the upper 104 and lower leg sections 142 at selected positions with respect to each other. The friction nut 144 includes an inner nut portion 146 that has outer threading and is secured to the bottom of the upper leg section 140. A tapered bottom 147 extends downward from the friction nut 144 and encloses a section of the lower leg section 142. The friction nut further includes an outer nut portion 148 having inner threading that engages the outer threading of the inner nut portion 146. A lip 149 is disposed over the tapered bottom 147 of the inner nut portion 146 and extends radially inward. When the outer nut portion 148 is threaded to move upward with respect to the inner nut portion 146, the lip 149 forces the tapered bottom 147 radially inward, such that it tightly engages around the lower leg section 142. The friction between the tapered bottom 147 and the lower leg portion 142 is thus increased, holding the upper 140 and lower leg sections 142 in place with respect to each other. Threading the outer nut portion 148 in the opposite direction with respect to the inner nut portion 146 loosens the tapered bottom 146 around the lower leg portion to permit sliding of the upper 140 and lower leg 142 portions so that the legs 30 can be moved between the expanded and collapsed positions.

FIGS. 1-5 show the jacket 90 of the stand. The jacket 90 fits over at least a portion of the frame 20 when in the opened position. In the embodiment shown, the jacket 90 fits over an upper area of the frame 20 terminating approximately at the breaks 38 of the legs 30. The jacket 90 could alternatively fit over a larger or smaller portion of the frame 20, and in some embodiments may completely cover the frame 20 when in the opened position. The jacket 90 is preferably made from a fabric composed of a lightweight, durable material that is suitable for outdoor use, such as canvas or nylon tent material.

As shown in FIGS. 2-5, the exterior of the jacket 90 includes a plurality of pockets 92. The pockets 92, 94 are receptacles for holding various items. The pockets 92, 94 are preferably provided in a variety of sizes and shapes so that a wide variety of items can be stored. For example, where food items are placed on the stand 10, large pockets 92 may be provided to accommodate snack foods such as chips that are held inside a large container such as a bag or bowl. The entire bag or bowl can thus be placed into the large pockets. Smaller pockets 94 may be provided for smaller items, such as beverages, condiments, snack foods in jars, or accessories such as utensils and napkins. The pockets 92, 94 may also be adjustable in size. In the example shown, some of the pockets 92, 94 include drawstrings 96 that can be tightened to reduce the size of the pocket, permitting a smaller container to be securely disposed within the pocket. The pockets 92, 94 may further be provided with closure mechanisms. The drawstrings 96 may serve this function, or other closure mechanisms including buttons, snaps, or hook and loop fasteners such as VELCRO® may be employed.

The jacket 90 may be provided with other or additional receptacles for storing goods. As shown in FIGS. 2-5, the jacket is further provided with a recess 98 that receives a bowl 100. The bowl 100 may be made of a rigid material, such as plastic. Food products such as dips or condiments can be placed directly in the bowl 100 instead of the pockets 92, 94 where leakage may occur. Alternatively, large bottles, such as two liter beverage bottles, can be secured in recess 98.

Fastening means may be provided to secure the jacket 90 to the frame 20. In FIGS. 8 and 9 the fastening means are attachment straps 102. The attachment strap 102 shown in FIG. 8 is sewn to the jacket 90 and wraps around an upper portion 34 of the leg, between the leg 30 and the respective support rods 50 attached thereto. In this embodiment the jacket 90 is permanently attached to the frame 20. An alternative attachment strap 102 including a snap 104 for removable attachment of the jacket 90 to the frame 20 is shown in FIG. 9. The attachment straps 102 are preferably provided for all of the legs 30, but may alternatively be provided for only some of the legs 30. Other attachment means may be provided as well. For example, the jacket 90 may fasten directly to the frame 20 without the straps. Where this method is employed, a male portion of a snap may be affixed to each of the upper leg joints 60, and a female portion of a snap affixed to an upper portion of the jacket 90 that contacts the joint 60 when the jacket 90 is disposed over the frame 20. When the jacket 90 is in place over the upper portion of the frame 20, the snaps can be engaged to secure the jacket 90 in place. Alternatively, other fasteners including buttons or hook and loop fasteners such as VELCRO® may be affixed to the upper joints 60 and the jacket 90 as described above.

The exterior of the jacket 90 may also be provided with handles 106 to assist in transporting the stand 10 when the frame 20 is in the opened state. As shown in FIG. 2, two handles 106 are provided at an upper portion of the jacket 90. When the jacket 90 is fastened to the frame 20, for example by the above described attachment straps 102, the entire stand 10 is held together and can be lifted and transported by the handles 106. The handles 106 may be made from any material sufficient to support the weight of the stand, and possibly additional weight attributable to goods stored in the pockets 92, 94 of the jacket 90. In the illustrated embodiment, the handles 106 are made from a fabric, such as a woven nylon fabric, but may also be made of other materials such as a molded plastic.

Portions of the jacket 90, such as outer surfaces of the pockets 92, 94, may be used to display information or images, including labels, or logos, such as the logo of a favorite sports team.

As shown in FIG. 1, the jacket 90 may also be configured to fit over the frame 20 when in the closed state. In the embodiment shown, the jacket 90 can be removed from the expanded frame 20 and turned inside-out prior to placing it over the closed frame 20. The pockets 90 are thus disposed within the jacket 90, to provide a more compact configuration. The interior of the jacket 90, disposed on the outside in FIG. 1 where the jacket 90 is shown turned inside out, may include a strap 108. The strap 108 can be made from similar materials to those described above with respect to the exterior handles 106. When the frame 20 is in the closed state, with the legs 30 collapsed, and disposed within the inside-out jacket 90, the entire stand can be transported by the strap 108, such that jacket 90 serves as a carrying case for the closed frame.

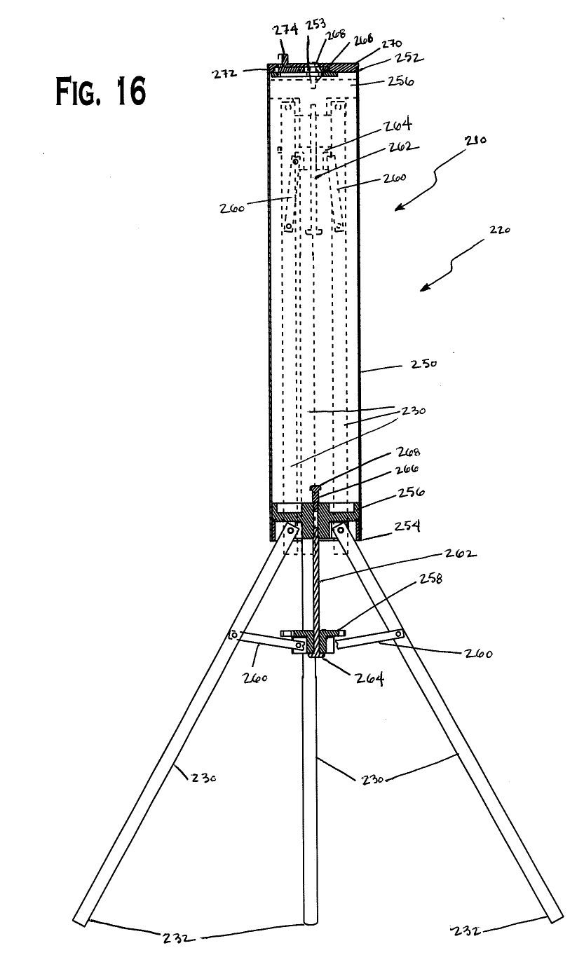

FIG. 16 shows an alternative embodiment of the stand 210. The frame 220 of this embodiment includes a tube 250 encasing legs 230. As shown, the tube 250 includes a top end 252 and a bottom collar 254. The legs 230 are attached the runner and extend from the bottom collar 254 when in the opened state. In this embodiment, three legs 230 are provided, but the frame 220 could include fewer or more legs 230 as well. As shown, the legs 230 extend at angles with respect to the shaft 250 to form a widened base.

The legs 230 of this embodiment are pivotally attached to a runner 256 within tube 250 for movement of the frame 220 between the opened and closed states. In the embodiment shown, pin connections pivotally connect the legs 230 to the runner 256. The frame 220 is moved towards the opened state by pivoting the legs 230 to increase an angle formed with respect to the shaft 250, and moved towards the closed state by pivoting the legs 230 to decrease an angle formed with respect to the shaft 250 until substantially parallel to the shaft 250.

In the embodiment shown, the runner 256 slides within the tubular body 250 to stow the legs 230 therein. FIG. 16 shows the legs 230 in the opened position in solid lines, and stowed in dashed lines. As shown, the space occupied by the frame 220 is greatly reduced when in the closed state with the legs 230 stowed within the shaft 250.

As shown in FIG. 16, the legs 230 are supported by a hub 258 and plurality of pivotable spokes 260. The hub 258 is disposed axially downward with respect to the runner 256 and connected thereto by an attachment post 262 on which the hub 258 is slidably mounted. The spokes 260 extend radially from the hub 258 and are pivotally connected by pins at opposite ends thereof to the hub 258 and the legs 230. The attachment post 262 includes a head 264 at a bottom end thereof that prevents the hub 264 from sliding off of the attachment post 262.

When the frame 220 is in the opened position, the attachment rod 262 protrudes outward from the bottom of the tube 250. The hub 258 is located at the bottom of the rod 262 in abutment with the head 264. The spokes 260 extend radially outward and axially upward with respect to the hub 258, connecting with respective legs 230 at opposite ends thereof to prevent inward pivoting of the legs 230, holding the frame 220 in the opened position. To close the frame 220, the hub 258 slides upward on the rod 262, and the spokes 260 pivot inward. The legs 230 can then be pushed upward, into the tubular body of the shaft 250, as shown in dashed lines in FIG. 16.

As shown in FIG. 16, the leg assembly is retained within the tube 250 by a pinhead 268 that extends from the top of the rod 262. When the leg assembly is stowed within the tube 250, the pinhead 268 extends above the tip 266 and through an opening 253 in the top 252 of the tube 250. As shown, the top 252 of the tube includes a fixed top wall 270 and a biased portion 272, which together defined the opening 253. A trigger 274 extends from the biased portion 272 through an opening in the fixed wall 270. The trigger 274 is used to retract portion 272 and release pinhead 268. Preferably, the biasing force is a spring.

The jacket 90 is similar to that described above, but may be sized to fit over the tubular shaft 250. A skirt that covers the legs 230 may be provided as well. The skirt may include additional pockets 92, 94. Alternatively, the skirt may include no pockets 92, 94 and instead be used simply to protect the legs 230 or to display images or logos. A full sized jacket 90 covering both the legs 230 and the shaft 250 may be provided as well.

In yet another embodiment of the stand 10, the jacket 90 is omitted and receptacles are directly attached to the frame 20, 220. Where the frame includes a tube 250, as described above, the receptacles may be attached to an outer surface of the tube and may be, for example, plates or bowls in which food products may be served. The plates or bowls may be attached by extensions on the shaft 250 such as clips or hooks.

While the preferred embodiments of the invention have been described in detail above, the invention is not limited to the specific embodiments described which should be considered as merely exemplary.

What is claimed is:

1. A collapsible stand comprising:
a frame that moves between a closed state and an opened state;
a jacket that fits over at least a portion of the frame; and
a plurality of receptacles supported on the frame.

2. The stand of claim 1 wherein the jacket encloses the frame when in the closed state.

3. The stand of claim 1 wherein the frame has a plurality of legs.

4. The stand of claim 3 wherein each of the legs pivots between collapsed and expanded positions.

5. The stand of claim 3 wherein the frame further comprises a plurality of support rods connecting respective adjacent ones of the plurality of legs, and the support rods pivot with respect to the legs to move the frame between the opened state and the closed state.

6. The stand of claim 5 wherein the legs are spaced about a perimeter of the frame and the support rods connect each of the legs to two adjacent ones of the legs on respective opposite sides thereof.

7. The stand of claim 6 wherein two support rods connect each of the legs to each of the adjacent legs, and the two support rods intersect and are pivotally connected at respective central portions thereof to form an accordion hinge.

8. The stand of claim 5 wherein each of the support rods comprises a first end fixedly pivotally connected to a selected one of the legs, and a second end slidably pivotally connected to an adjacent one of the legs, and the second end slides along a length of the adjacent leg when the frame moves between the open state and closed state.

9. The stand of claim 4 wherein each of the legs comprises a break that divides the leg into an upper section and a lower section, and the lower section pivots with respect to the upper section to move the leg between the collapsed and expanded positions.

10. The stand of claim 9 wherein the upper section and lower sections comprise separate elongate tubular bodies joined at respective ends thereof by a connector that extends through the break.

11. The stand of claim 9 wherein each of the legs moves towards the expanded position when the lower section pivots to increase an angle formed with respect to the upper section, and moves towards the collapsed position when the lower section pivots to decrease an angle formed with respect to the upper section.

12. The stand of claim 11 wherein the upper and lower sections are substantially equal in length and each of the legs move towards the collapsed position when the lower section pivots outward with respect to the upper section.

13. The stand of claim 11 wherein the lower sections are shorter in length than the upper sections, and each of the legs moves towards the collapsed position when the lower section pivots inward with respect to the upper section.

14. The stand of claim 11 wherein the upper sections include joints that engage the lower sections and hold the upper and lower sections substantially parallel when in the collapsed position.

15. The stand of claim 3 wherein the legs comprise a plurality of telescoping members.

16. The stand of claim 3 wherein the frame further comprises a shaft having a top end and a bottom end, and each of the legs is connected to the bottom end to form a base when the frame is in the opened state.

17. The stand of claim 16 wherein the legs pivot with respect to the shaft to move the frame between the opened state and the closed state.

18. The stand of claim 17 wherein the legs are substantially parallel to the shaft when the frame is in the closed state.

19. The stand of claim 18 wherein the shaft is tubular and the legs are slidably stowable within the shaft.

20. The stand of claim 1 wherein the receptacles comprise pockets formed in the jacket.

21. The stand of claim 20 wherein the receptacles further comprise containers disposed within the pockets.

22. The stand of claim 1 wherein the jacket comprises at least one of a handle or strap for transporting the stand.

23. A stand comprising:
an upper frame that moves between a compact closed position and an expanded opened position;
at least three supports, connected to the upper frame that are biased toward the opened position; and
a plurality of receptacles supported on the upper frame.

24. A method of using a collapsible stand, comprising:
providing collapsible stand comprising a frame that supports a plurality of food storage receptacles and moves between an opened state and a closed state, the frame having a plurality of legs and a plurality of support rods pivotally connecting respective adjacent ones of the plurality of legs to move the frame between the opened state and the closed state;
closing the frame by pivoting each of the support rods with respect to each of the legs connected thereto to reduce an angle formed therebetween and move the legs closer together; and
expanding the frame by pivoting each of the support rods with respect to each of the legs connected thereto to increase an angle formed therebetween and move the legs further apart.

25. The method of claim 24 wherein each of the legs comprises a break that divides the leg into an upper section and a lower, the method further comprising collapsing each of the legs by pivoting the lower section about the break to decrease an angle formed with respect to the upper section.

26. A method of using a collapsible stand, comprising:
providing a collapsible stand comprising a frame that supports a plurality of food storage receptacles and moves between an opened state and a closed state, the frame comprising a tubular shaft having a top end and a bottom end, and a plurality of legs pivotally connected to the bottom end;
closing the frame by pivoting each of the legs with respect to the shaft to decrease an angle formed with respect to the shaft until substantially parallel to the shaft and sliding the legs into the shaft; and
opening the frame by sliding each of the legs outward from the shaft and pivoting the legs with respect to the shaft to increase an angle formed with respect to the shaft to form a widened base.
